(19) United States
(12) Patent Application Publication
(10) Pub. No.: US 2025/0384236 A1
(43) Pub. Date: Dec. 18, 2025

(54) Binary Magnetic Strip Polymer(Plastic) Strip Card

(71) Applicant: Reginald Keith Sapp, CLINTON, MD (US)

(72) Inventor: Reginald Keith Sapp, CLINTON, MD (US)

(21) Appl. No.: 18/745,258

(22) Filed: Jun. 17, 2024

(51) Int. Cl. G06K 19/06

(52) U.S. Cl. CPC G06K 19/06187

(57) ABSTRACT

The card body FIG. 1 is a strong Polymer (Plastic) which is not easily bendable and will function with a Magnetic Strip FIG. 2 as in a cassette tape or Reel to Reel to its reader.

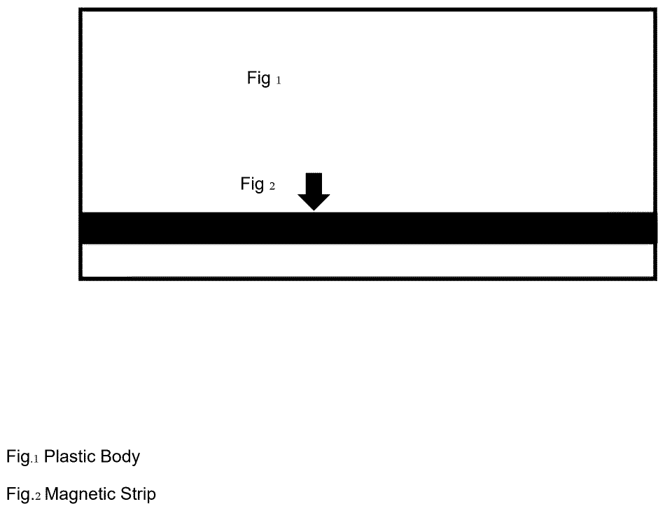

The Binary Magnetic Strip Polymer (plastic) Strip Card includes research in Electronics Engineering, Mechanical Engineering and Drafting. The body of the Binary Magnetic Strip Polymer (plastic) Strip Card FIG. 1 is plastic.

The Magnetic strip FIG. 2 is a film for binary storage. It is a tape equal to the tape of a cassette and its binary properties. It is an electronic digital method for all applications of binary uses. There is a need for a security method with storage of binary code on the strip FIG. 2 for all applications of business. This security is formed from this invention using machine language called Binary.

We research magnetism with Binary in an application. We can extract the code from the strip FIG. 2 to a reader.

We found that it will read the code and yield it code to a reader for positive output. We examine other models that read binary.

The use of magnetism with binary resulted in positive reading with the capability of code writing.

1. We found thought research that a binary strip of code FIG. 2 can be read and written by readers. We also researched and found that a small portion of Magnetic Strip FIG. 2 will store the binary code as in a memory disk.

2. The magnetic strip FIG. 2 attached to the polymer card body FIG. 1 with magnetic voltage of 5+ volts in strength will store in memory, read and write from the memory the binary code over and over. The receiver will read the stored memory binary code and respond.

3. For example: A door in a secured building, a connection to a bank, to a cashier check out, to unlock if lock by binary application any door, vault, passage . . . et al.
